(19) United States
(12) Patent Application Publication
(10) Pub. No.: US 2024/0144571 A1
(43) Pub. Date: May 2, 2024

(54) System for Derivation of Consistent Avatar Appearance Across Metaverse Ecosystems

(71) Applicant: AT&T Intellectual Property I, L.P., Atlanta, GA (US)

(72) Inventors: Eric Zavesky, Austin, TX (US); James H. Pratt, Round Rock, TX (US); Nigel Bradley, Canton, GA (US)

(73) Assignee: AT&T Intellectual Property I, L.P., Atlanta, GA (US)

(21) Appl. No.: 17/974,033

(22) Filed: Oct. 26, 2022

(51) Int. Cl. G06T 13/40; G06F 3/01

(52) U.S. Cl. CPC G06T 13/40; G06F 3/011

(57) ABSTRACT

Aspects of the subject disclosure may include, for example, receiving avatar definition information from a user, the avatar definition information defining aspects of a user avatar to represent the user in an immersive experience in a first metaverse; activating the user avatar in the first metaverse, the user avatar defined according to the avatar definition information; and activating the user avatar in a second metaverse, the user avatar representing the user in the second metaverse, the user avatar defined in the second metaverse according to the avatar definition information, the activating the user avatar in the second metaverse being responsive to a request from the user to change from the first metaverse to the second metaverse. Other embodiments are disclosed.

### FIELD OF THE DISCLOSURE

The subject disclosure relates to a system for derivation of consistent avatar appearance across multiple metaverse ecosystems, for example in immersive reality, augmented reality, virtual reality, mixed reality or extended reality systems.

### BACKGROUND

The metaverse includes a set of technologies that combine to create an immersive experience for one or more users. The immersive experience may occur in a persistent virtual world that continues to exist even after a user has left the virtual world. Metaverse worlds can be created using immersive reality, augmented reality, virtual reality, mixed reality or extended reality. A user may participate in the metaverse using a virtual reality headset or goggles or another device.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a process for establishing a user avatar that may be accessed or implemented on multiple platforms.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for establishing a normalized appearance and other aspects of an avatar for a user across multiple metaverses for immersive experiences and the like. The user may establish a baseline appearance including a reference image or reference images that anchor representations of the avatar in the different metaverses. Platforms or other systems can negotiate adjustments to avatar appearance to satisfy requirements or policies of the platforms or metaverses. The avatar may evolve over time as user preferences change or as platform requirements change. Other embodiments are described in the subject disclosure.

One or more aspects of the subject disclosure include receiving, from a user, information about a user avatar to be associated with the user during user activities in a first metaverse, receiving, from the user, a request to extend use of the user avatar to a second metaverse, activating the user avatar in the second metaverse, representing the user by the user avatar in the second metaverse, and receiving, from the user, information about second metaverse user activities in the second metaverse.

One or more aspects of the subject disclosure include receiving, from a user, avatar definition information defining user preferences and user selections for a user avatar to be activated in a first metaverse, the first metaverse operative to provide a first immersive experience to the user via virtual reality equipment worn by the user, activating the user avatar in the first metaverse, the user avatar defined according to the user preferences and the user selections of the user to establish a visual appearance of the user avatar in the first metaverse; receiving, from the user, a request to switch to a second metaverse, the second metaverse operative to provide a second immersive experience to the user via the virtual reality equipment worn by the user; and activating the user avatar in the second metaverse, including maintaining the user preferences and user selections to maintain a visual similarity of the user avatar in the second metaverse with the visual appearance of the user avatar in the first metaverse.

One or more aspects of the subject disclosure include receiving avatar definition information from a user, the avatar definition information defining aspects of a user avatar to represent the user in an immersive experience in a first metaverse; activating the user avatar in the first metaverse, the user avatar defined according to the avatar definition information; and activating the user avatar in a second metaverse, the user avatar representing the user in the second metaverse, the user avatar defined in the second metaverse according to the avatar definition information, the activating the user avatar in the second metaverse being responsive to a request from the user to change from the first metaverse to the second metaverse.

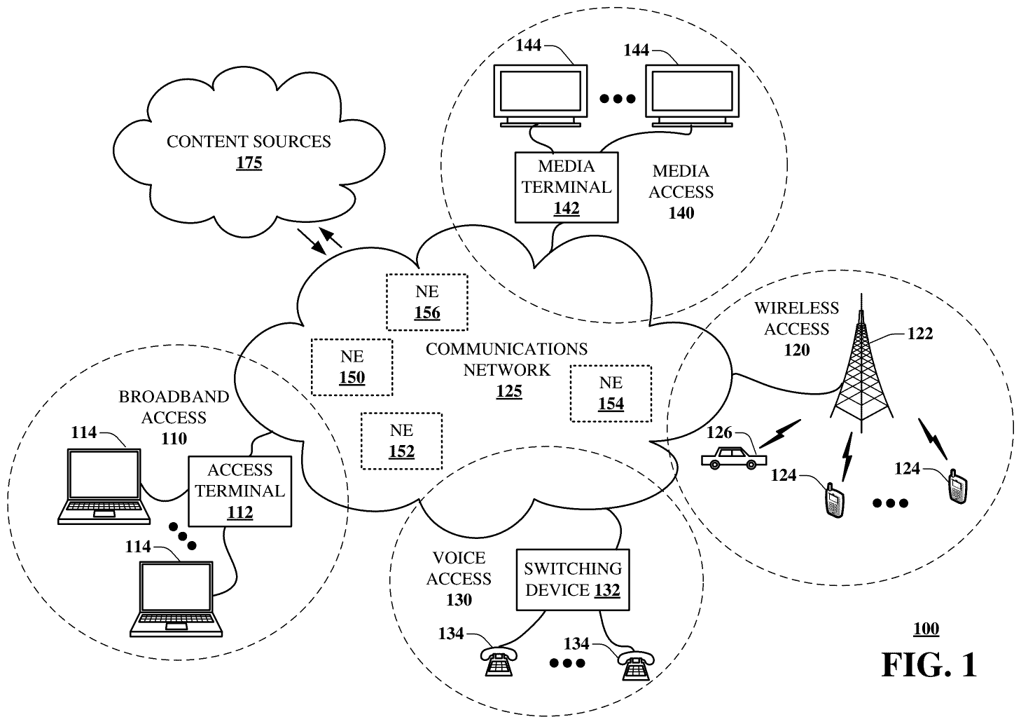

Referring now to FIG. 1, a block diagram is shown illustrating an example, non-limiting embodiment of a system 100 in accordance with various aspects described herein. For example, system 100 can facilitate in whole or in part creation of an avatar of a user for use in a metaverse and that can be extended to other metaverses as well by the user. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

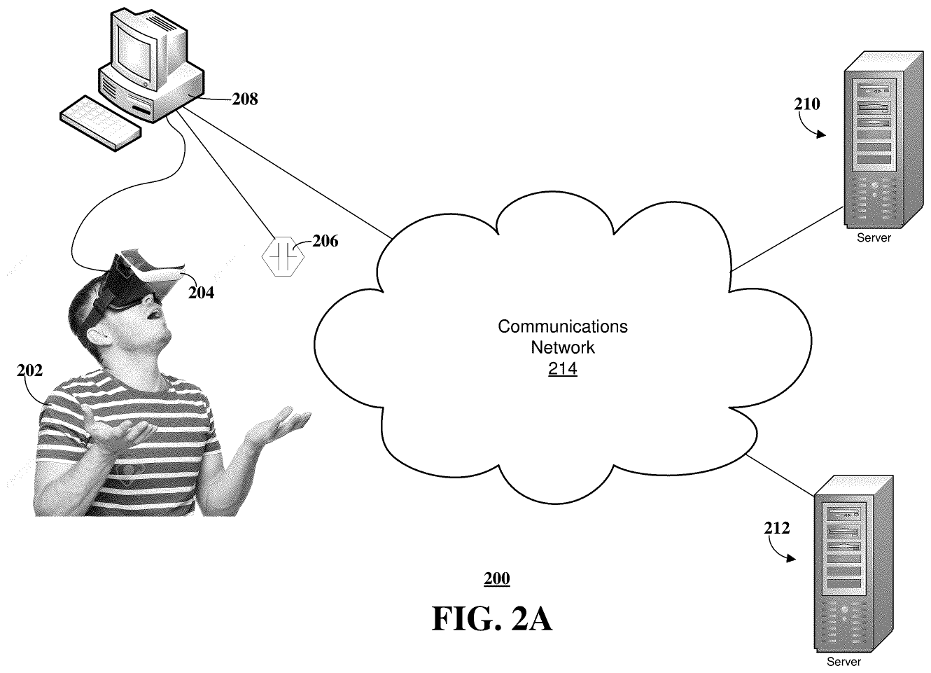

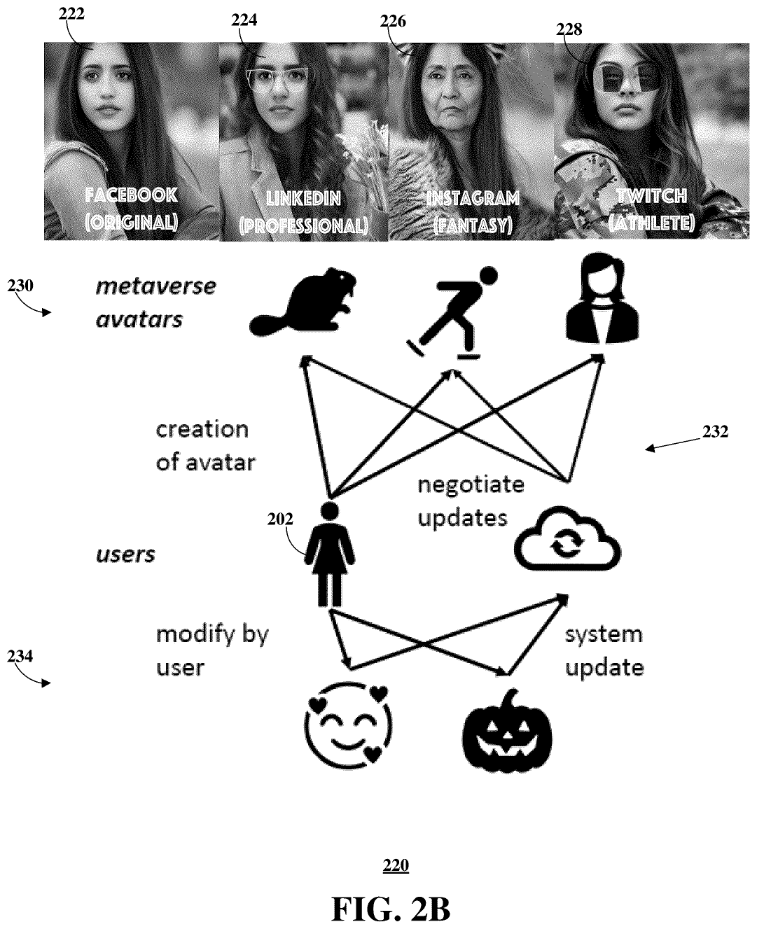

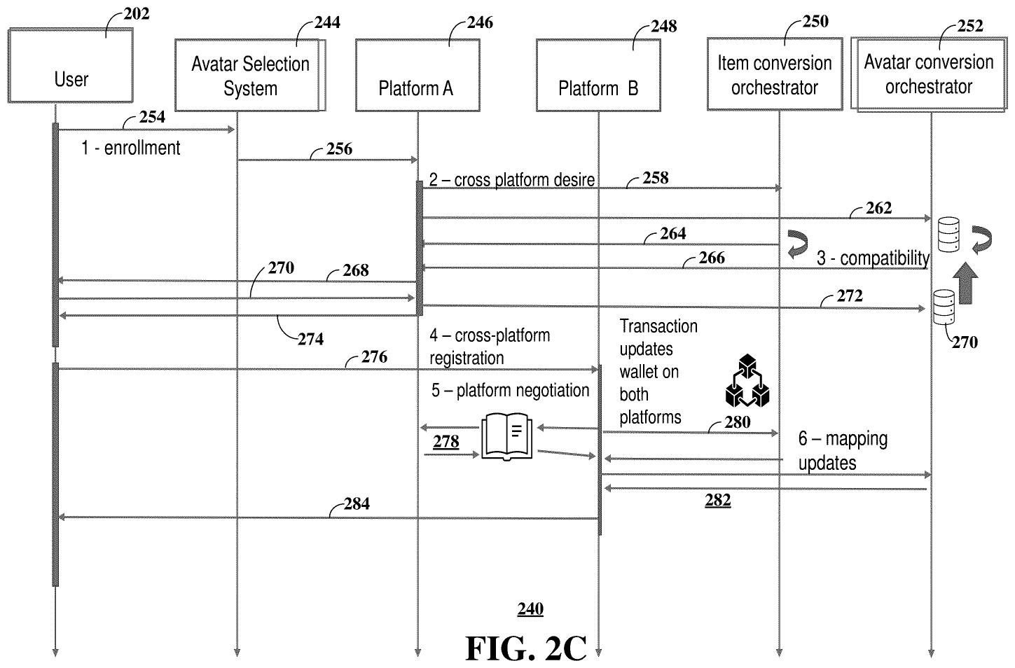

FIG. 2A is a block diagram illustrating an example, non-limiting embodiment of a system 200 functioning within the communication network of FIG. 1 in accordance with various aspects described herein. The system of FIG. 2A may be used by a user 202 to engage in an immersive experience in the metaverse.

The metaverse includes a set of technologies that combine to create an immersive experience for one or more users. The immersive experience may occur in a persistent virtual world that continues to exist even after a user has left the virtual world. Metaverse worlds can be created using immersive reality, augmented reality, virtual reality, mixed reality or extended reality. In some examples, a metaverse experience can include an online or digital economy where users can create, buy and sell goods and services.

For participating in a metaverse, a user may act through an avatar. An avatar is a manifestation of a user in the metaverse. The avatar can have visual, audible, physiological and other aspects that are selected, assigned or designed by the user. Such aspects include appearance, and an avatar can be made to appear with any characteristics of the user, such as the user's actual real-world appearance or a cartoon appearance or a hybrid of real-world and virtual elements. The avatar can be equipped with virtual objects and abilities. Such aspects may include any sort of preferences or profiles or features the user may specify. A user's avatar may change and evolve over time, under control of the user, as the user experiences the metaverse and moves among different metaverses.

Information defining aspects and features of a use's avatar may be stored in any suitable format and at any suitable location. For example, a user's avatar data may be stored locally on a device such as a gaming platform used by the user to access an online game. In another example, the user's avatar data may be stored at a remote server system, including the server that implements a game or other metaverse. In yet another example, the user's avatar data may be stored at any suitable network location accessible over a network such as the public internet.

As used herein, a platform on which a user avatar is displayed may be a network site or destination providing network facilities and functions for interaction by a user accessing the platform using a user device. The user device may be a mobile device such as a smartphone, a laptop or desktop computer, a gaming console, a virtual reality headset or other processing system. The avatar may interact with, or create the appearance of interacting with, other avatars or facilities of the platform. A platform may provide a variety of services and resources such as a gaming system, social media, shopping, new and entertainment.

Current and future implementations include multiple metaverses. Different organizations offer different online or network accessible platforms enabling metaverse experiences. For example, the company known as Meta Platforms, Inc., offers one or more metaverses. The company known as Alphabet, Inc., separately offers one or more metaverses. The company known as Amazon.com, Inc., separately offers one or more metaverses. The company known as Accenture plc offers design and build services to assist clients building their own proprietary metaverses.

Each respective metaverse from each respective organization has its own features. Each metaverse may be distinct. In some instances, different metaverses may be joined and there may be transferal, so that users can travel among multiple metaverses. Features and aspects of respective metaverses may be incompatible with those of other adjacent or competing metaverses.

Users may wish to participate in different immersive experiences in the different metaverses of the different organizations. In examples, one or more metaverses may include games for both single-user play and multiple-user play. One or more metaverses may be designed for professional cooperation among individuals in a virtual office environment. One or more metaverses may be designed for training and participants may include students and trainees and teachers or trainers. Over the course of a day or any amount of time, a user may move through and experience several different immersive experiences in several different metaverses, offered by different organizations.

A problem arises in the creation and deployment of users' avatars across multiple metaverses. Some metaverse platforms require that a user must onboard user preferences, content and specifications associated with the user's avatar. This must be done according to each platform's specifications. Because of platform-to-platform differences, taking an avatar from one platform to another may be difficult or impossible. This requires export and import of content between platforms and may be subject to inconsistencies among the platforms.

In some cases, metaverse platforms may put in place interoperability agreements to control and specify transfer of data among such platforms. However, such agreements may lack definition of a fallback, restoration or adjustment mechanism in the event data is lost or platform requirements or specifications change or evolve. For example, platforms and user preferences or capabilities may change. For the platform, such capabilities and preferences may include three-dimensional (3D) or two-dimensional (2D) rendering capabilities, limitations on displayable visual features or limitation of use of animals as avatars. For a user, such capabilities and preferences may include a particular facial expression of the avatar, such as smiling, rendering the avatar in color or black and white and rendering the avatar in 3D or 2D. However, the proposal of adjustments and how to accommodate may not be well addressed in an interoperability agreement.

In a further example, existing intellectual property rights may limit portability of avatars. For example, one platform may have rights under a license or other agreement to enable users to define avatars that appear like characters in a film, such as Pirates of the Caribbean. The appearance of such characters may be protected as intellectual property such as copyright or trademark rights. If the user seeks to transfer the user's avatar to another platform that lacks the necessary license rights, the user may be limited or excluded from transferring the avatar. If the platform to which the user transfers the avatar has similar avatar appearance available, the transfer of appearance and capabilities must be handled within the context of the intellectual property rights at issue.

Further, a user may change the appearance or other settings of the user's avatar in one immersive reality platform. Such changes must be handled in other immersive reality platforms in which the user participates. This may be under control of the user who may not desire all changes to be reflected in avatars in other platforms. The platforms should cooperate to enable the user to cross an avatar from one platform to another, choose which avatar or platform is best, choose which avatar or platform is appropriate and update avatar definitions across platforms.

Currently, some messenger applications may provide a user icon including a picture of the user. The icon in the messenger application may actually reference a photo held by a third party, not the messenger application itself. The user sets up the photo of the user on the third-party web site. The photo is then referenced indirectly at the messenger application, rather than the user moving the photo among applications or other sources. Current virtual reality does not have in place agreements to recast or represent a user's avatar in a different virtual environment in any way.

Referring again to FIG. 2A, it shows a block diagram illustrating an example, non-limiting embodiment of a system 200 functioning, for example, within the communication network 100 of FIG. 1 in accordance with various aspects described herein. The system 200 in this embodiment enables a user 202 to interact with an immersive experience in an extended reality (XR) environment. The system 200 in this embodiment includes a virtual reality (VR) headset 204 wearable by the user 202, one or more sensors 206, a user computer 208, a first metaverse platform 210 and a second metaverse platform 212 accessible over a communications network 214.

The VR headset 204 enables the user 202 to experience, generally, an XR environment, where XR is a general term intended to encompass XR, virtual reality (VR), mixed reality (MR) and augmented reality (AR) systems, equipment and environments. The VR headset 204 generally includes a data processing system including one or more processors, a memory for storing data and instructions, and a communication interface. The VR headset 204 provides visual display to the user 202 and may include one or more display screens within the VR headset 204 to control the view seen by the user 202 and the environment experienced by the user. Further, the VR headset 204 may include a camera for capturing images of the environment of the user. The VR headset 204 may include speakers to provide sound information to the user 202 and the VR headset 204 may include one or more microphones to collect sound information about the environment of the user 202. In other embodiments, the VR headset 204 may be embodied as AR glasses or goggles or other wearable devices or may be operated in conjunction with a fixed display system such as a computer monitor, television or series of display screens in the physical environment with the user 202.

The sensors 206 may include any sort of condition sensing and data collection apparatus suitable for the embodiment of the system. The sensors may include one or more cameras that collect images of the physical environment near the user 202. The cameras may collect visual images, infra-red images and others. The sensors 206 may include environmental sensors that collect information such as temperature, wind speed, orientation or acceleration, or other physical factors of the environment where the user 202 is located. The sensors 206 may further gather information about the user 202. Such information may include biometric information, such as pulse rate or respiratory rate, skin conductivity, pupil dilation, haptic information about one or more touches of the user 202, and so forth. Thus, the sensors may include or be part of a wearable device such as a watch, belt or harness. Further, such user data may include information about the position, posture and movement of the user. Any sort of data that may be useful by the system 200 for monitoring the user 202 and controlling the XR environment may be sensed by the sensors 206. In some embodiments, the sensors 206 merely sense a condition and report information. In other embodiments, one or more of the sensors 206 may be controllable, such as by the user computer 208.

The user computer 208 is in data communication with the VR headset 204 and the sensors 206. In the illustrated embodiment, the user computer 208 has wireline connections to the VR headset 204 and the sensors 206. In other embodiments, the wireline connections may be supplemented or replaced with one or more wireless connections, such as a Wi-Fi connection according to the IEEE 802.11 family of standards or a Bluetooth connection according to the Bluetooth standard.

The user computer 208 cooperates with the VR headset 204 to provide the XR environment for the user 202. The user computer 208 communicates with the VR headset 204 to provide video information, audio information and other control information to the VR headset 204. The user computer 208 communicates with the sensors 206 to collect information about the physical environment and the user 202. The user computer 208 communicates with the first metaverse platform 210 and the second metaverse platform 212 to provide video and other information from the VR headset 204 to the first metaverse platform 210 and the second metaverse platform 212 and to provide information and data from the sensors 206 to the first metaverse platform 210 and the second metaverse platform 212. The video and data may be sent in any suitable format, including encoding to reduce the amount of data transmitted or encrypted to maintain security of the data. The user computer 208 communicates to the VR headset 204 virtual reality information to the VR headset 204. In some embodiments, the functionality provided by the user computer 208 may be combined with the VR headset 204. In the embodiment of FIG. 2A, the user computer 208 is shown as a desktop computer. However, any suitable processing system, including one or more processors, memory and communications interface, may implement the functions of the user computer 208.

The first metaverse platform 210 and the second metaverse platform 212 control provision of one or more metaverse environments to the VR headset 204 for the user 202. The first metaverse platform 210 and the second metaverse platform 212 generally include a processing system including one or more processors, a memory for storing data and instructions and a communications interface. The first metaverse platform 210 and the second metaverse platform 212 may be implemented as a single server computer, as multiple server computers at one or multiple locations or in any suitable manner. In the system 200, the first metaverse platform 210 and second metaverse platform 212 implement independent metaverses and may be operated by the same organization of different organizations.

The first metaverse platform 210 and the second metaverse platform 212 receive over the communications network 214 information about the environment of the user 202, including location information, information about objects in the environment and events occurring in the environment. The first metaverse platform 210 and the second metaverse platform 212 in some embodiments may further receive information about the user 202, including biometric information and information about the performance of the user 200. The information may come from the sensors 206, the VR headset 204, or any other source. Under control of the first metaverse platform 210 and the second metaverse platform 212, control information is provided over the communications network 214 including video information, sound information, haptic information and any other information, including instructions and data, to the other components of the system 200 including the user computer 208 and the VR headset 204.

The first metaverse platform 210 and the second metaverse platform 212 each develops a metaverse including an XR environment as a combination of the actual environment in which the user 202 is located and a simulated or virtual environment, to achieve ends such as training, entertainment, education, performance improvement, and behavioral improvement for the user 202. In other embodiments, other metaverse platforms may create additional metaverses accessible by the user 202 and other users, not shown in FIG. 2A. Multiple users may engage each other in a metaverse generated and controlled by the first metaverse platform 210 or the second metaverse platform 212. Further, each user including user 202 may be represented in a respective metaverse by an avatar.

The user 202 may specify aspects of an avatar to represent the user 202 in a metaverse controlled by the first metaverse platform 210 or the second metaverse platform 212. The user 202 may specify visual aspects of the avatar and audible aspects of the avatar. The user 202 may specify other features of the avatar such as objects carried or possessed by the avatar or skills, abilities and other characteristics of the avatar. The user 202 may specify aspects of the avatar in any suitable manner, such as be interacting with the user computer 208. For example, the user 202 may use the user computer 208 to access a web page presented by of the first metaverse platform 210 or the second metaverse platform 212, or by a third party. Using facilities of the web page, the user may specify characteristics of the avatar which the user selects to represent the user in one or more metaverses. After defining the avatar according to requirements and preferences of the user 202, data corresponding to the avatar may be stored in any suitable location, such as the user computer, the first metaverse platform 210 or the second metaverse platform 212, or another location accessible over the communications network 214.

The communications network 214 may include any combination of wireline and wireless communication networks, including but not limited to broadband access network 110, wireless access network 120, voice access network 130 and media access network 140 (FIG. 1). The communications network 214 may include the internet and may provide access to other devices and services as well.

Referring now to FIG. 2B, it depicts an illustrative embodiment of a process 220 for establishing a user avatar that may be accessed or implemented on multiple platforms. In an example, a user 202 establishes as the user avatar a mouse-head shape. As the avatar, the mouse-head shape forms a manifestation of a user in each respective platform. A platform may include one or more websites including social media websites. In the example of FIG. 2B, a first platform 222 provides a website labelled Facebook; a second platform 224 provides a website labelled LinkedIn; a third platform 226 provides a website labelled Instagram; and a fourth platform 228 provides a website labelled Twitch. These platforms are intended to be exemplary only. Any combination of network-accessible properties may be accessed by the user 202 for interaction by the user 202 including by means of an avatar. In embodiments, the platforms may communicate with each other and with other network elements, particularly as regards characteristics of a user avatar.

The user may, for example, take an original photo displayed on first platform 222 as a first avatar and modify the photo for use as an avatar on the second platform 224. In this example, the second platform 224 may be adapted for professional interactions and meetings and job search. Thus, in this example, the user has modified the first avatar to have a more adult, professional, or serious appearance, with glasses and a more serious expression and more styled hair. The user has further modified the photo of the first avatar for the third platform 226. In this example, the third platform 226 may have a fantasy focus for users so the user has modified her appearance to appear much older, with wrinkled features and modified attire. The fourth platform 228 may have a young, energetic athletic atmosphere so the user has modified the original photo from the first avatar to appear more athletic, with sport glasses and attire and stylish hair. Thus, the user can select or assign specific identities to each avatar. The identities may be characterized as “social,” “gamer,” “professional,” and “fantasy.” Any other examples of identities or personalities may be used along with the widest variety of photo avatars or graphical avatars such as cartoons, and modifications thereof.

Each platform may provide a variety of online services and be accessible over a communications network such as communications network 214 of FIG. 2A and including the public internet. In the example, each platform may provide social media interaction among users such as the user. Each platform may provide a metaverse. While active on the platform, either in a social media environment or in a metaverse or otherwise, the user is presented as an avatar. An avatar may be a manifestation of a user on the platform including in the metaverse. The avatar can have visual, audible, physiological and other aspects that are selected, assigned or designed by the user.

A first aspect of the process 220 includes a process 230 of avatar definition. The avatar may be established using a reference image from either a single source of data that is accessible by the user or a shared source of data that is accessible by the user and some or all of the platforms on which the avatar is to appear. In an example of the process 230, a user baseline for avatar appearance or other significant characteristics is established; this baseline appearance may be visualized as the exemplar 224 image. The user baseline may include a single image, a segment of video, a segment of sound or any other characteristic that may uniquely associate the user avatar with the user. The user avatar serves as a source identifier for other participants on the platforms and for the platforms themselves. The participants or platforms experience the user avatar visually audibly or in any sense and are thus able to associate the user avatar with the user. Actions or comments or purchases or any other online activity by the avatar may be ascribed to the user as the source thereof.

In one example, the user 202 may access an avatar selection system such as a website to select, define and design a user avatar. In one example, the user 202 may select among preexisting avatar shapes such as a beaver, an athlete and a person. In embodiments, the user can select the avatar and further specify aspects of the appearance of the avatar, such as demographics (e.g. age, gender, ethnicity, etc.). This can be done in any suitable fashion, including the identification or specification of a user profile of the user 202, where the user profile stores information for customizing or personalizing aspects of the user avatar. The avatar with the specified appearance will form a reference image or avatar anchor around which the user avatar is to be built. Alternatively, the user's selection may instead merely select an image to serve as a token or reference image, without specifying visual or other aspects of the appearance of the avatar. The selected token then forms an avatar anchor around which the avatar is to be built. In a second example, a set of images from multiple data sources is accessed to form the baseline for the user avatar. The set of images forms a set of reference images. In an embodiment, multiple platforms may cooperate with the user to select a reference image or set of reference images that are representative of the user. The reference image or images, however chosen, together form a baseline for one or more user avatars of the user. In a related embodiment, an avatar's anchor may be related to (or defined by) identifiers that contain a protocol (how to convey an appearance or information about a user) and an identifier (which appearance or information attribute) to emphasize. One such identifier that is growing in utility among virtual platforms is the DID (Decentralized Identifiers within the W3C set of standards as of Jul. 19, 2022).

From the baseline, the process 220 includes addressing differences in handling of avatars among the different platforms including the first platform 222, the second platform 224, the third platform 226 and the fourth platform 228. Each platform may have different, unique requirements, limitations and policies for specifying avatars. For example, some platforms may prohibit certain types of content such as adult content or images or sounds covered by intellectual property laws. Some platforms may permit content which is otherwise covered intellectual property but for which the platform has a license or other permission to use. Some platforms may be technologically limited, such as able to display any visual image characteristics of a user avatar but unable to play audio or video content of the user avatar. The user avatar must conform to the policies of each platform. The result may be creation of a single user avatar that applies to all platforms. In other embodiments, the result may be creation of multiple user avatars where each respective user avatar may be applied to one or more respective platforms, according to the policies of each respective platform.

In a process 232, the process 220 include modifying the baseline or avatar anchor according to requirements and policies of each respective platform. In embodiments, the process 232 may include a negotiation between the two or more platforms in which the avatar anchor is modified based on platform requirements or policies. In an example, the C may have the profile of Mickey Mouse which may be covered by copyright protection. A first platform may have a policy to exclude obvious likenesses of copyright protected material and thus require substantial modification to the avatar anchor. In contrast, a second platform may have a license to reproduce or modify the copyright protected image and may therefore permit the avatar anchor. The differences in policies may be automatically negotiated between the platforms to obtain a single user avatar or a set of user avatars that may be used on respective platforms according to platform policies.

In another example, the platforms or respective metaverses within platforms may negotiate characteristics of a user avatar within each metaverse. For example, one metaverse may be a game that simulates human interaction with dinosaurs and requires a specified type of caveman attire for the user avatars for players. A second metaverse may implement an online meeting place between colleagues and business partners and may require business casual attire for the user avatars for participants. The platforms or the metaverses within the platforms may negotiate a common or a unique appearance and other aspects for the user avatar of the user 202. Thus, in the example, in the second platform 224, the user avatar associated with the user 202 is a professional or robot. To convert a likeness form the original image 222 to the second platform image 224, exemplar keywords (or attributes) may be “inside flower shop, sports jacket, glasses. In the third platform 226, the user avatar associated with the user 202 is a beaver or cat. In the fourth platform 228, the user avatar associated with the user 202 is an athletic ice skater. To convert the original likeness 222 to the fourth platform 228, exemplar keywords (or attributes) may be “camouflage pattern jacket, tactical military glasses.”

In another example, the avatar anchor may include features which may be prohibited or permitted according to policies of different metaverses or services of a respective platform. In an example, a platform operated by a particular organization operates a first metaverse that includes a game set in medieval times, a second metaverse that includes a futuristic game set in the year 2520, and a social media site. Policies of the platform may limit attire for a user avatar in the medieval times game to medieval garb only. Similarly, the policies of the platform may limit attire for user avatars in the futuristic game to supposed futuristic clothing only. The social media site may have no policies for attire for user avatars for participants in the social media site. In another example, the user avatar in a first metaverse may be human like and in a second metaverse, the user avatar may be an alien from space. Each metaverse may specify aspects of skin for humans and skin for aliens and, as a result, the two resulting user avatars may have different appearing skin to better match the surroundings in an immersive experience in the first metaverse and the second metaverse. Thus, within each platform, different policies may apply to user avatars active on different products or services of the platform.

In another example, the avatar anchor may include multiple channels including, in one example, an image channel, a video channel and an audio channel. Aspects of each channel may be negotiated or resolved by cooperation between the metaverses or the platforms. In one example, a first metaverse may permit an image to be combined with a video portion and an audio portion with no limitations. Further, a second metaverse may permit the audio portion to be combined with the image but may limit video content to black and white video only, with no color video permitted. The content of the user avatars that are presented on each respective metaverse or each respective platform may be tailored to requirements and policies for respective channels.

In embodiments, then, aspects of each respective user avatar are automatically negotiated or decided upon by the platforms or by functions of the metaverses operating on the platforms. The negotiation or resolution of user avatar aspects including visual aspects, audible aspects, actions and activities of the user avatars, may be decided for each platform or for each metaverse or other product according to established policies and requirements. The policies and requirements of the platforms and the metaverses may change and evolve over time.

Based on the agreed user avatar appearances for each platform or each metaverse, each respective platform develops an understanding of what resources the platform needs to represent the user 202 as a user avatar in the space respective metaverse. The platform determines what resources are needed to convey either from that initial avatar anchor or from the personalized version of the avatar anchor of the user 202 what the platform needs to convey the user avatar for each of the different metaverses.

In a third process 234, aspects of the user avatar are modified or updated based on inputs from the user 202 or the platforms or the metaverses. For example, the user 202 may modify an aspect of the avatar anchor selected or created by the user at process 230. The modification may apply to an appearance characteristic of the avatar anchor for the user 202 such as having a bald head. The modification may further apply to another aspect of the user 202 such as being newly married. The modification to the avatar anchor may propagate through all representations or all user avatars in all platforms and all metaverses. In example, a user avatar initially appears as an ice skater. Following modification, the user avatar is made to appear as a jack-o'-lantern.

In another example, the user 202 may modify one or more aspects of a respective user avatar in a single respective metaverse. For example, only the robot avatar in the second platform may be given a bald head, or only the ice skater avatar in fourth platform may be changed to being married. The respective platform or metaverse will respond by adjusting the user avatar accordingly.

In a further embodiment, the platform or metaverse may continue to apply rules or policies to definitions of user avatar characteristics. In this embodiment, some modifications requested by the user 202 may not be applied to the user avatar on a particular platform or metaverse. In an example, the user 202 may modify a user profile to assert that the user 202 enjoys drinking a certain brand of alcoholic beverage. A first metaverse may have a rule against explicitly naming brands and therefore will not make the requested modification. A second metaverse may have a policy against promoting consumption of alcoholic beverages because of the presence of users other than 21 years of age and therefore will not make the requested modification.

Other rules and policies may be made to apply to user avatars in particular metaverses. For example, the policy against using content covered by intellectual property rights of others may also be extended to cover proprietary content that is not necessarily covered by an intellectual property right. For example, a content owner may choose not to share content created by the content owner on one or more platforms or one or more metaverses, perhaps for fear of misappropriation of the content item. The content item may thus be protected, or a policy created against sharing that content as part of a user avatar.

In another example, rules or policies may be set to control appearance of a user avatar based on any suitable categorization of a user and, for example, a metaverse space or metaverse colleagues. In one example, if the user is participating in a metaverse with formal requirements, such as a professional meeting or formal social event, policies may limit the appearance of the user avatar to only business attire, for the professional meeting, or formal evening wear for the formal social event. If the user attempts to clothe the user's avatar in short pants and a sleeveless shirt, the existing policies will prevent such an action. The policy may be set by the metaverse or a platform hosting the event. Alternatively, the policy may be set by the user seeking to control user appearance to only appropriate appearances.

In another example, policies may be based on other participants in a metaverse or on a platform. The policy may gain awareness, in some embodiments, of the social circles of the user. For example, the metaverse may link to one or more social networking accounts of the user and obtain information about friends and acquaintances of the user as well as information about the extent of a relationship such as close friends, casual acquaintances, etc. One or more policies may then control the appearance and behavior of the user avatar for the user. For example, in a metaverse where the user engages only persons who are casual business contacts, the appearance of the user avatar may be limited to nothing more casual than business casual attire and words, phrases and other language used by the avatar may be limited to more formal language. In contrast, in a metaverse that is more casual, such as a group of long-term friends watching a sporting event together, the permitted attire and permitted language, according to a policy or rules, may be much more casual. The context of the metaverse, including locale, activities and attendees, controls aspects of the user avatars in the metaverse based on policies or rules that are established.

Still further, policies that are related to context may be combined if they apply to a current metaverse or platform. For example, a policy that has two levels of permitted activity for a user avatar depending on a virtual location of the metaverse, such as an office environment or a restaurant environment, may be combined with a policy that has two levels of permitted attire for the user avatar so that, in the office environment, the avatar must wear business attire and may not drink alcoholic beverages. In the restaurant environment, more casual attire is permitted, and alcoholic beverages are permitted for the user avatar.

One goal for the user avatar is to maintain a consistent appearance or a consistent representation of the user. This may limit the changes that can be made to a respective user avatar in a respective metaverse. For example, a user has a pirate as a user avatar in a first metaverse and a robot as a user avatar in a second metaverse. If the user changes the avatar anchor for both user avatars to add an earring to the appearance, that may be acceptable. Both a pirate avatar and a robot avatar may be acceptable in a particular context with an earring. However, if the user attempts to change the avatar anchor so that the avatar anchor is wearing a pirate costume, that would be fine for the pirate avatar and withing context. However, for the robot avatar, a pirate costume may be out of context for the current avatar or the current metaverse. Such as change may be blocked or limited.

In other examples, appearances of a user avatar may reflect changes to a user profile or other user preferences. For example, the user may specify in a profile a particular style of haircut, for example. The user may then control the user avatars and the metaverses to which the updated style of haircut is applied. Another example relates to skin color or texture of an avatar. The user may select blue skin tones in a first metaverse and green skin tones in a second metaverse, or red skin tones across all active metaverses.

In some embodiments, any aspect of a user avatar, including visual and audible aspects, may be selected by the user. In embodiments, the user may establish a profile in which some or all aspects of the user avatar are selected and stored. In embodiments, the user may select or be presented with a web page or other computer-accessible resource that provides a dashboard or question-and-answer process for selecting the user avatar's characteristics or specifying the user's preferences. Preferences can specify what metaverses particular avatar characteristics should apply to. The profile or other user-specified avatar information may be ready by a data processing system upon entry of the user or activation of the user in a particular metaverse. The profile may be re-read from time to time to detect changes may be the user or other sources so that changes to avatar aspects may be detected an applied.

Similarly, social media comments or other detected comments made by the user may trigger a modification to the appearance of one or more user avatars of the user. In an example, the process 234 for modifying a user avatar may have access to comments made by the user on one or more social media platforms or in other venues such as electronic mail, text messages or even voice telephone calls. Comments made in any of these or other venues may cause the process 234 to modify one or more aspects of a user avatar. For example, if the user changes a user status on a social media page to assert that the user is “happy,” the process 234 may modify the appearance of one or more user avatars of the user to appear happy, with a smile or other indicia. Similarly, if the user states in a telephone call an emotion of being concerned, the process 234 may change the appearance of an avatar to one of concern as change an audio file that is played for the user avatar to a preselected audio clip that conveys a serious tone for the avatar in one or more metaverses. The appearance of the user avatar may be changed to match detected contextual conditions of the user, the environment, the immersive experience, and others. The changes to the avatar's appearance may be recorded in the user's profile or any other suitable location.

In some embodiments, a platform or metaverse may enforce particular restrictions on aspects including the appearance of a user avatar. In an example, a professional platform or metaverse intended for communication among professional peers may limit expression of emotion by participants. Aspects such as smiles and friendly voice that evoke warmth and respect may be permitted by the platform while aspects that convey anger or sorrow are limited or excluded in an attempt to maintain a professional atmosphere. If a user modifies a user avatar or an avatar anchor to create a sorrowful expression and mournful manner of speech, the professional platform may disallow the modification. Upon receipt of a request to modify the user avatar on the professional platform, for example, during a negotiation of process 232, the request may be logged or recorded but no action may be taken. Further, in some examples, the user may be provided with a notification or warning, in any suitable format, that such aspects of a user avatar are not permitted on the professional platform.

In other examples, a platform or metaverse may have the ability to detect for the user which profile is appropriate for the user. For example, because of platform policies, particular avatars or avatar characteristics may be excluded from the platform. Similarly, the processing system of the user which selects a user avatar, may detect a desired or requested destination platform or metaverse of a user and override the user's selection of a user avatar as being inappropriate or unusual. In one embodiment, the processing system tracks what user avatar aspects the user conventionally uses in a particular metaverse. If the user selects something other than the conventional choice, the processing system may interrupt to ask the user to verify the selection or prohibit the selection based on awareness of platform policies or other information.

FIG. 2C depicts an illustrative embodiment of a method 240 in accordance with various aspects described herein. The method 240 enables a user 202 using a processing system to establish aspects of a user avatar using an avatar selection system 244. The user avatar may then be used to represent the user 202 on multiple platforms, including platform A 246 and platform B 248. The method 240 in embodiments includes an item conversion orchestrator 250 and an avatar conversion orchestrator 252. The item conversion orchestrator 250 manages information and activities between the user 202, platform A 246 and platform B 248 when an object associated with the user avatar of the user 202 is extended from one platform or one metaverse to another. The avatar conversion orchestrator 252 manages information and activities between the user 202, platform A 246 and platform B 248 when a user avatar or an avatar anchor is extended from one platform or one metaverse to another.

At step 254, the user 202 enrolls in one or more platforms or systems. In the exemplary embodiment, each platform, platform A 246 and platform B 248, present one or more metaverses in which the user 202 may participate. Participation for the user may be via a user avatar. In step 254, the user selects, specifies or establishes the aspects of the user avatar or of an avatar anchor. In the enrollment process of step 254, avatars can be created by the user at any time and the avatars may be registered in any suitable fashion to the user's identify. In embodiments, the avatar selection system 244 may be an application program or other software item running on the user's data processing system or a remote data processing system accessible over a network.

The avatar selection system 244 may present a user interface such as a dashboard or graphical user interface to the user through which the user can select aspects of the user avatar or of an avatar anchor. One aspect the user can select is a desire or the ability for the user avatar of the user to cross from one platform or from one metaverse to another. Also, in embodiments, the user avatar may be established with a blockchain or other ledger system that can record activities such as changes to aspect of the user avatar or ownership of the user avatar. In other embodiments, the user avatar may be associated with a non-fungible token (NFT). An NFT is a record on a ledger such as a blockchain that represents pieces of digital media. The NFT can link to particular aspects of the user avatar or the avatar token such as an appearance aspect or an audible aspect. For example, if the user 202 creates an original musical jingle that plays whenever the user's avatar appears in a metaverse, similar to a batter's walk-up song that is played when the batter approaches home plate to bat in a baseball game, the original musical jingle can be associated with an NFT to create an exclusive claim of the user to the original musical jingle. The avatar selection system 244 may provide options for the user 202 to specify the musical jingle and create or associated an NFT for the jingle. NFTs may be created for any aspect of the user avatar.

Following the activities by the user 202 to enroll in the avatar selection system 244, step 256 may include an operation of communicating information about the user's avatar to platforms selected by the user. In this example, the user selects to provide avatar information to platform A 246 and to platform B 248. In examples, the user may select to provide only information about an avatar anchor which may then be further enhanced by user selections or by a respective platform or metaverse. Alternatively, the user may select to provide a full complement of descriptions of avatar aspects, including visual information and audible information and other information, to one or more platforms.

At step 258, the user's desire to be able to cross from one platform or metaverse to another, or to have the user's user avatar cross over, is implemented. In some examples, the ability to cross among platforms or metaverses may be based on invitation. In such a case, a default condition may be that the user avatar may not cross over to a different metaverse. The user's avatars on the two different platform are not connected functionally or in any other way and are not synchronized. In an example, the user avatar is designed only for and only may be active in a particular, defined platform or metaverse. If an alternative metaverse or platform invites the user to extend to the alternative metaverse, the user may at step 258 takes steps to enable or activate the user avatar on the alternative metaverse. In the example, the user 202 cooperates with the avatar conversion orchestrator 252. The invitation to extend or cross over to the other metaverse may be communicated in any suitable manner, such as a message communicated to the user at the avatar selection system 244. The user may modify the avatar at this time for any reason. Moreover, aspects of the user avatar may be automatically modified, or requested modifications may be declined, based on rules or policies of the alternative metaverse.

In other embodiments, the user may express a desire for the user's avatar to be able to cross over or extend from, for example, platform A 246 to platform B 248. The user may express this desire in any suitable fashion, such as through control of the avatar selection system 244. In some examples, the user may have a single identity per platform or metaverse. In other examples, the user may have multiple identities per platform and one or more user avatars for the multiple identities. When the user enrolls, and when the user avatar becomes active on multiple metaverses or platforms, the user avatars may be tied to a specific identity of the user.

At step 262, step 264, step 266, step 268, step 272 and step 274, the avatar conversion orchestrator 252 cooperates with user 202 and platform A 246 and platform B 248 to determine a most compatible version of the user avatar to specify for the user. This is comparable to the negotiation process of process 232, corresponding to a negotiation between the two or more platforms in which the avatar anchor or user anchor is modified based on platform requirements or policies. In example embodiments, the most compatible version of the user avatar is a version which includes aspects specified by or requested by or preferred by the user 202, which also do not violate any rules or policies of the desired platforms of the user, including platform A 246 and platform B 248 in this case. Other definitions of the most compatible version of the user avatar may be used as well.

In an example, one or more prior avatar models are retrieved and may be adapted according to user preferences and platform policies. A preliminary version of an avatar anchor or a user avatar may be completed according to the user's preferences. Subsequently, in step 262, step 264, step 266, and step 268, the negotiation process may change aspects of the user avatar such as appearance, body form and style according to user preferences, platform policies and known alterations.

In another example, the avatar conversion orchestrator 252 may automatically adapt aspects of the user avatar of the user 202 for translation to a different world presented by other platforms such as platform B. In an example, platform A 246 is based on earth. Platform B 248 presents and aquatic environment. The avatar conversion orchestrator 252 may automatically adapt visual and other aspects of the user avatar to appear appropriately in an aquatic environment. In an example, if the user avatar appears to be a cowboy in a metaverse operating on platform A 246, the avatar conversion orchestrator 252 may modify the appearance of the user avatar to appear as an underwater diver in the aquatic environment of the metaverse operating on platform B 248 when the user 202 activates the user avatar on platform B 248. Objects associated with the user avatar may be automatically converted by the avatar conversion orchestrator 252. For example, the cowboy avatar is armed with a six-shooter gun and a Bowie knife. After conversion, the diver avatar is armed with a spear gun and a knife. Aspects including visual aspects of the user avatar and objects associated with the avatar are automatically modified to match the context when the user avatar become active in a new metaverse.

In step 272, final negotiated user avatar specifications are stored in a database 270. Similarly, at step 274, the final negotiated user avatar specifications are reported to the user 202. The specifications may be stored in any suitable location or in any suitable format.

At step 276, a cross-platform registration operation is initiated. The cross-platform registration may correspond to a desire of the user 202 to move or extend the user avatar from a first platform such as platform A 246 to a second platform such as platform B 248.

Extension of an avatar from one platform or metaverse to another may require some negotiation, step 278. The extension of the user avatar from a source platform or a source metaverse to a destination platform or a destination metaverse may require some negotiation among the platforms to find mutually acceptable aspects of the avatar. Mutually acceptable aspects include those aspects of the user avatar which do not violate any rules or policies of either platform or metaverse. In some embodiments, respective aspects of an avatar may be handled or negotiated individually. For example, first skin tone and skin texture may be negotiated. Then clothing or attire may be negotiated. Then audio aspects such as the voice of the user avatar may be negotiated. Alternatively, the negotiation may be conducted at a high level of abstraction, such as “the avatar looks like a pirate,” or “the avatar looks like a person who sails and not like an office worker,” or “does not look human; looks like an animal.” Further, the negotiation may compare capabilities of the avatars to maintain consistency so that the avatar who can leap to great heights on platform A 246 has the same ability on platform B 248.

In some examples, the user 202 may overlay specific preferences for each specific platform and those preferences may operate to override an aspect of the user avatar. For example, the user may access a professional meeting metaverse and have established a preference for the user's only appearing on the professional meeting metaverse dressed in business attire. In that example, the user preference expressed for the professional meeting metaverse overrides the appearance of the user avatar dressed as a pirate. Such preferences may have a hierarchy among platforms or among aspects and the user may establish the hierarchy using the avatar selection system 244 for example. In this case, the user's preference for the professional meeting metaverse as a destination metaverse overrides the user's preference for pirate attire in a gaming source metaverse where the pirate avatar originated.

In some embodiments, the negotiation of step 278 may involve the user 202. For example, the negotiation may be interactive for acceptance by the user of a translation of an aspect of the user avatar or for personalization of an article associated with the user avatar. In an example, the user prefers that the avatar wear a pirate costume that is covered intellectual property of another which is permitted by the policies of the source platform. However, the destination platform has a policy that does not permit the particular pirate costume, perhaps due to lack of a license or other agreement with the third-party rights holder. The automatic negotiation will select an alternative pirate costume for the avatar but will request confirmation from the user 202 before proceeding.

In some examples, some aspects of the user avatar may be licensed or purchased. The negotiation of step 278 may involve negotiation between systems for paid items which require further payments for use in other systems or may have a grandfathered use. In one example, an aspect of a user avatar may be protected by one or more intellectual property rights of another. For example, if the avatar is given the appearance of a pirate and the pirate appearance includes aspects of the character Jack Sparrow from the film Pirates of the Caribbean, the user 202 may be required to pay a fee or other compensation to use the likeness of the character Jack Sparrow. In another example, a visual aspect or an audible aspect may be associated with an NFT. The use of the NFT by an avatar may require payment of a license fee, a royalty fee or other compensation. Step 278 may include a negotiation of payments for use of protected rights and extension of rights from a licensed platform to a new platform requiring a license.

Any sort of agreement or arrangement may be negotiated to cover compensation for rights such as intellectual property or NFTs, including waiving any fees under specified circumstances. For example, the arrangement or transaction may be covered by a smart contract. A smart contract may be defined as a self-executing contract with the terms of the agreement between the parties being directly written into lines code. The code and the agreements contained therein exist across a distributed, decentralized blockchain network. In another example, the user 202 may contract, through a subscription agreement, with a service provider, such as an internet service provider, to obtain access to platforms operated by third party organizations. Separately, the internet service provider may contract with the third-party platforms to allow subscribers to access the metaverses of the third-party platforms.

At step 280, information about modifications to an object associated with the user avatar as a result of extending the avatar to a new platform is provided to the item conversion orchestrator 250. The item conversion orchestrator 250 manages information and activities between the user 202, platform A 246 and platform B 248 when an object associated with the user avatar of the user 202 is extended from one platform or one metaverse to another. In some embodiments, information about user avatars and contractual obligations and payments may be maintained in a wallet or other data resource associated with the user avatar or the user on each respective platform. Alternatively, a separate wallet or other data file or resource may be stored in a network accessible location for the user 202 and include information for all avatars of the user on all platforms.

At step 282, any updates or modifications to a user avatar or an avatar anchor are shared among the avatar conversion orchestrator 252 and the platforms including platform A 246 and platform B 248. In some embodiments, adaptation models and parameters may be extracted from the user avatars and information may be stored as an exemplar for future items or future appearance for objects or exemplars that may be in in a similar class or have a relationship to the current object or exemplar. Further, step 282 may include a process of receiving labeling information from the user 202. The labeling information may express user preferences for the user avatar. In some embodiments, the labeling information may be used in conjunction with one or more machine learning models. The updates are further communicated to the user 202 at step 284.

A system and method in accordance with some features described herein enables a user to participate in multiple metaverses on multiple platforms using a single user avatar. Such platforms have traditionally operated independently and with little to no crossover by a user or the user's identify. However, the system and method according to features described herein enable a degree of interoperability between metaverse systems and further enable self-expressions of the user that are consistent among the metaverse systems. Further, as metaverse systems or games evolve and age and are eventually no longer used, the user may continue with a consistent representation of the user's self in different environments. Still further, the system and method according to some aspects described herein enable adaptability of individual characters developed for one worldly environment into another worldly environment. For example, a human character as a user avatar functioning in an Earth environment may be readily translated to an alien form in an extra-terrestrial environment. Conversions of an avatar can be controlled and accounted for between metaverse systems based on automated platform negotiations including the user of smart contracts of other persistent ledger systems to monitor and track modifications to an avatar. The user may select an avatar independently of the metaverse system.

In some embodiments, items associated with a particular user avatar may have features that may be upgraded or given a different treatment or heightened priority. An example is an item bearing a third-party trademark or other intellectual property protection. Also, a user may in some cases designate an item as having a high priority or as being upgraded in the context of the metaverse or multiple metaverses. Different metaverses may handle upgraded items differently and the platforms may include in negotiations a conclusion about how an upgraded item in a first metaverse will be handled in the second metaverse.

In some embodiments, items of one game or metaverse may be adapted when moving to another metaverse. In an example, a sword possessed by a user in a first metaverse may be translated to a bow in a second metaverse. The adaptation may be based on a developed understanding of storyline in each respective metaverse and the usefulness of objects in each storyline in each universe. As an example, if the metaverse is a game involving medieval battle, a sword has substantial value to a user and user avatar. If the user avatar moves to a different platform to a game involving battle with lasers and energy fields, the utility of the sword will be more limited so that sword may be automatically transformed to a laser weapon for the user avatar in the second metaverse.

In some embodiments, one or more external marketplaces may develop for transacting in user avatars, avatar characteristics and object to be associated with a user avatar. For example, a custom, stylized user avatar may be designed and offered for sale or rent on specified terms. A user may then acquire the rights to use that avatar in one or more metaverses. The rights may limit the extent to which the user can modify the avatar or the particular platforms or metaverses on which that avatar may be used. The original design of the avatar may specify and control how the avatar is modified when extended to other platforms or metaverses. For example, the original avatar may be developed for a metaverse in which avatars appear photo-realistically. If the avatar is extended to a metaverse in which avatars appear as cartoons, the original definition of the avatar may control how the photo image of the avatar is softened or modified for the new cartoon metaverse. The avatar's appearance is already tuned for application to the other metaverses.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

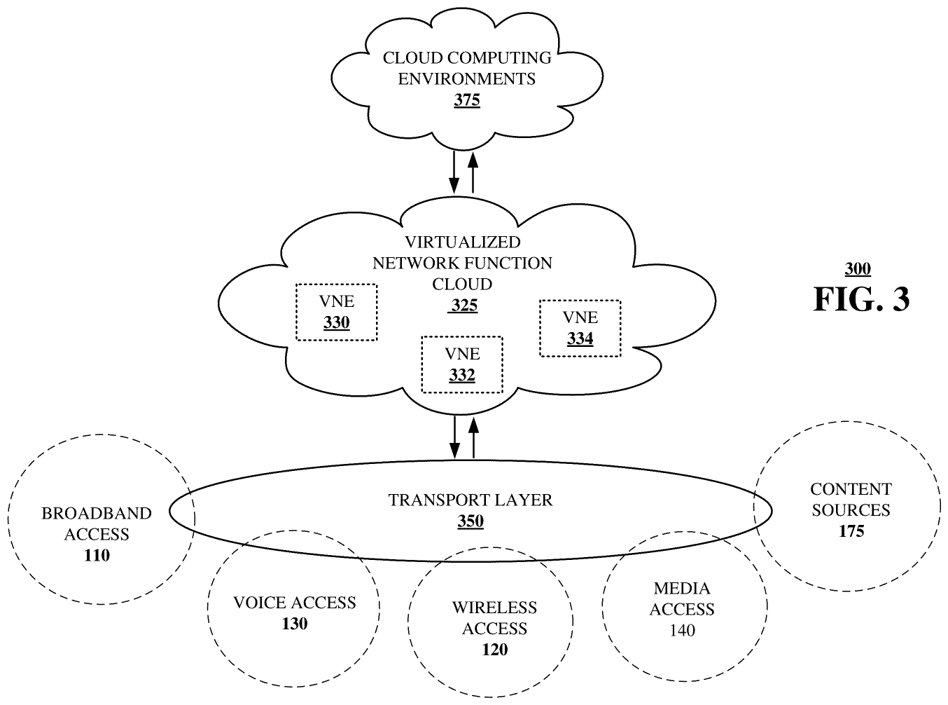

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, process 220 and method 240 presented in FIG. 1, FIG. 2A, FIG. 2B, FIG. 2C, and FIG. 3. For example, virtualized communication network 300 can facilitate in whole or in part creation of an avatar of a user for use in a metaverse and that can be extended to other metaverses as well by the user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

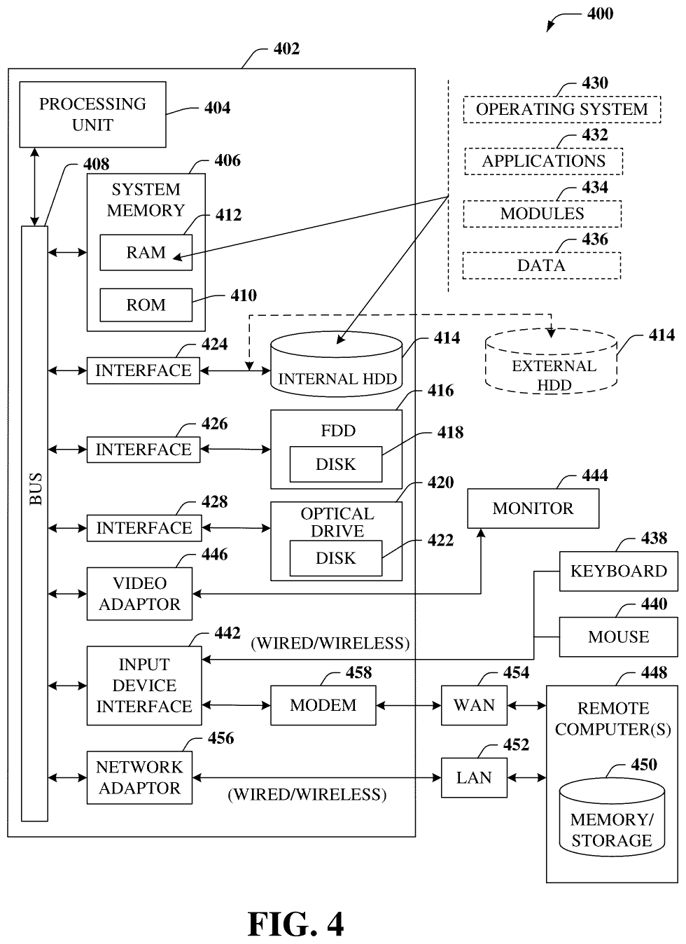

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part creation of an avatar of a user for use in a metaverse and that can be extended to other metaverses as well by the user.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

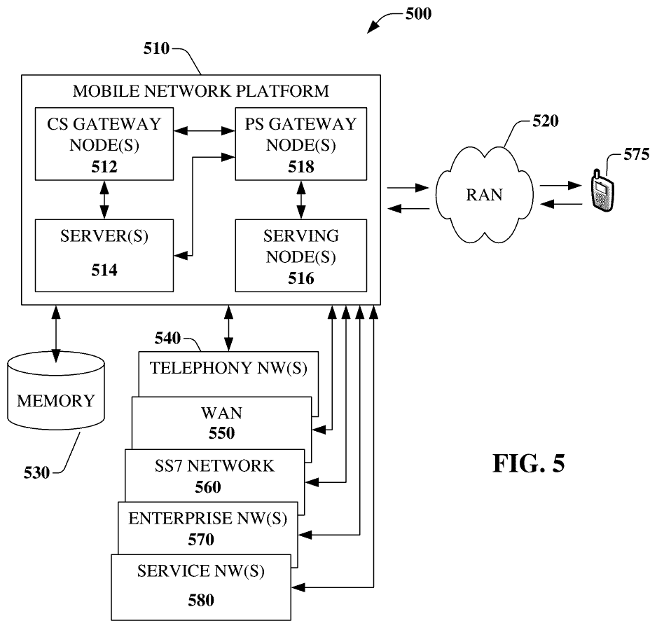

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part creation of an avatar of a user for use in a metaverse and that can be extended to other metaverses as well by the user. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

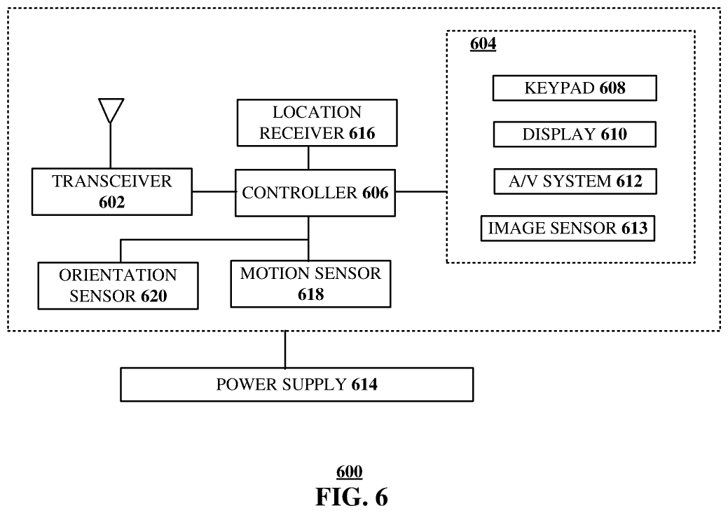

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part creation of an avatar of a user for use in a metaverse and that can be extended to other metaverses as well by the user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, from a user, information about a user avatar to be associated with the user during user activities in a first metaverse;
receiving, from the user, a request to extend use of the user avatar to a second metaverse;
activating the user avatar in the second metaverse;
representing the user by the user avatar in the second metaverse; and
receiving, from the user, information about second metaverse user activities in the second metaverse.

2. The device of claim 1, wherein the operations further comprise:
receiving, from the user, information defining aspects of the user avatar, the information defining aspects of the user avatar including information defining visual aspects of the user avatar; and
modifying visual appearance of the user avatar in the first metaverse according to the information defining aspects of the user avatar, forming a modified user avatar, the modified user avatar having a modified visual appearance.

3. The device of claim 2, wherein the operations further comprise:
representing the user with the user avatar with the modified user avatar when the user is active in the second metaverse, the modified user avatar in the second metaverse maintaining the modified visual appearance.

4. The device of claim 3, wherein the operations further comprise:
determining avatar policies of the first metaverse; and
limiting the modifying the visual appearance of the user avatar according to the avatar policies of the first metaverse.

5. The device of claim 4, wherein the operations further comprise:
determining avatar policies of the second metaverse responsive to the receiving the request to extend use of the user avatar to a second metaverse;
automatically negotiating aspects of the modified user avatar to conform the visual appearance of the modified user avatar to the avatar policies of the first metaverse and the avatar policies of the second metaverse;
representing the user with the modified user avatar when the user is active in the first metaverse; and
representing the user with the modified user avatar when the user is active in the second metaverse.

6. The device of claim 1, wherein the operations further comprise:
associating, with the user avatar, one or more objects in the first metaverse; and
maintaining the one or more objects in association with the user avatar when the user avatar is activated in the second metaverse.

7. The device of claim 6, wherein the operations further comprise:
assessing a fee for use an object of the one or more objects by the user avatar in the first metaverse.

8. The device of claim 7, wherein the operations further comprise:
negotiating use of the object of the one or more objects by the user avatar in the second metaverse.

9. The device of claim 1, wherein the operations further comprise:
providing to the user a user interface to receive the information about user avatar;
receiving, from the user at the user interface, information defining visual aspects of the user avatar;
receiving, from the user at the user interface, information about audible aspects of the user avatar; and
receiving, from the user at the user interface, information about physiological aspects of the user avatar.

10. The device of claim 1, wherein the operations further comprise:
activating the user avatar in the first metaverse, wherein access to the first metaverse is provided over a network by a first platform; and
in response to the request to extend use of the user avatar to a second metaverse, activating the user avatar on the second metaverse, wherein access to the second metaverse is provided over a network by a second platform, the second platform being independent of the first platform.

11. A non-transitory machine-readable medium, comprising executable instructions that, when executed by a processing system including a processor, facilitate performance of operations, the operations comprising:
receiving, from a user, avatar definition information, the avatar definition information defining user preferences and user selections for a user avatar to be activated in a first metaverse, the first metaverse operative to provide a first immersive experience to the user via virtual reality equipment worn by the user;
activating the user avatar in the first metaverse, the user avatar defined according to the user preferences and the user selections of the user to establish a visual appearance of the user avatar in the first metaverse;
receiving, from the user, a request to switch to a second metaverse, the second metaverse operative to provide a second immersive experience to the user via the virtual reality equipment worn by the user; and
activating the user avatar in the second metaverse, including maintaining the user preferences and user selections of the user to maintain a visual similarity of the user avatar in the second metaverse with the visual appearance of the user avatar in the first metaverse.

12. The non-transitory machine-readable medium of claim 11, wherein the operations further comprise:
receiving avatar policies of the first metaverse; and
defining the user avatar according to the user preferences and the user selections of the user, and according to the avatar policies of the first metaverse.

13. The non-transitory machine-readable medium of claim 12, wherein the operations further comprise:
receiving avatar policies of the second metaverse; and
automatically resolving differences between the user preferences and the user selections of the user, the avatar policies of the first metaverse and the avatar policies of the second metaverse to provide a conforming user avatar; and
activating the conforming user avatar on one of the first metaverse or the second metaverse, or both.

14. The non-transitory machine-readable medium of claim 13, wherein the operations further comprise:
receiving, from a user, avatar modification information, the avatar modification information defining different user selections for the user avatar; and
modifying one or more aspects of the user avatar according to the avatar modification information.

15. The non-transitory machine-readable medium of claim 14, wherein the operations further comprise:
modifying appearance of the user avatar according to the avatar modification information in both the first metaverse and the second metaverse.

16. The non-transitory machine-readable medium of claim 14, wherein the operations further comprise:
modifying appearance of the user avatar according to the avatar modification information in one of the first metaverse and the second metaverse according to user request.

17. A method, comprising:
receiving, by a processing system including a processor, avatar definition information from a user, the avatar definition information defining aspects of a user avatar to represent the user in an immersive experience in a first metaverse;
activating, by the processing system, the user avatar in the first metaverse, the user avatar defined according to the avatar definition information; and
activating, by the processing system, the user avatar in a second metaverse, the user avatar representing the user in the second metaverse, the user avatar defined in the second metaverse according to the avatar definition information, the activating the user avatar in the second metaverse being responsive to a request from the user to change from the first metaverse to the second metaverse.

18. The method of claim 17, comprising:
assigning, by the processing system, to the user avatar an object for use by the user avatar in the first metaverse;
assessing, by the processing system, to the user, a fee for use of the object by the user avatar in the first metaverse, where user of the object in an immersive experience is subject to rights of a third party; and
automatically negotiating, by the processing system, terms of an agreement, the agreement permitting usage of the object by the user avatar in the second metaverse.

19. The method of claim 18, comprising:
incorporating, by the processing system, the terms of the agreement in a smart contract.

20. The method of claim 17, comprising:
receiving, by the processing system, first metaverse avatar policies;
receiving, by the processing system, second metaverse avatar policies; and
negotiating, by the processing system, aspects of the user avatar according to the avatar definition information, the first metaverse avatar policies and the second metaverse avatar policies to provide a single user avatar that applies to all metaverses including the first metaverse and the second metaverse.
